(19) United States
(12) Patent Application Publication
(10) Pub. No.: US 2025/0253652 A1
(43) Pub. Date: Aug. 7, 2025

(54) RADIATION-HARDENED MODULAR MULTIMODAL POWER CONVERSION SYSTEM

(71) Applicant: Hamilton Sundstrand Corporation, Charlotte, NC (US)

(72) Inventors: Baljit Riar, Rocky Hill, CT (US); Suman Dwari, Vernon, CT (US); Parag M. Kshirsagar, South Windsor, CT (US); Parikshith Channegowda, Marlborough, CT (US); Michael Anthony Futrell, Rockford, IL (US)

(21) Appl. No.: 18/433,901

(22) Filed: Feb. 6, 2024

(51) Int. Cl. H02J 1/12; H02J 50/23; H02J 50/27; H02J 50/30; H02M 1/00; H02M 3/158

(52) U.S. Cl. CPC H02J 1/12; H02J 50/23; H02J 50/27; H02J 50/30; H02M 1/008; H02M 3/1584

(57) ABSTRACT

Embodiments of the disclosure provide an electric power distribution (EPD) system that includes a first power conversion system electronically connected between a first voltage source and a bus, along with a second power conversion system electronically connected between the bus and a first load. The first power conversion system is operable to, responsive to receiving power that originated from the first voltage source in a first modality, generate a first voltage and provide the first voltage to the bus. The second power conversion system is operable to, responsive to receiving a bus-voltage of the bus, generate a second voltage and provide the second voltage to the first load. The bus-voltage is greater than the second voltage.

### BACKGROUND

The present disclosure relates in general to electrical power generation and delivery systems. More specifically, the present disclosure relates to a radiation-hardened modular multimodal power conversion system.

Electrical power generation and delivery systems are designed to generate, transmit, and distribute electrical energy to loads. Electrical power generation and delivery systems include a variety of equipment, such as electrical generators, electrical motors, power transformers, conductive cables for electrical distribution and/or communication (referred to herein generally as “transmission lines”), circuit breakers, switches, buses, transmission and/or feeder lines, voltage regulators, capacitor banks, and the like. Such equipment can be monitored, controlled, automated, and/or protected using intelligent electronic devices (IEDs) that receive electric power system information from the equipment, make decisions based on the information, and provide monitoring, control, protection, and/or automation outputs to the equipment.

A microgrid is a self-sufficient energy system that serves a discrete geographic footprint, such as a college campus, hospital complex, business center or neighborhood. Within microgrids are one or more kinds of distributed energy (e.g., solar panels, wind turbines, combined heat and power, generators) that produce its power. In addition, microgrids can include energy storage, typically from batteries. Some also now have electric vehicle charging stations. Interconnected to nearby buildings, the microgrid provides electricity and possibly heat and cooling for its customers, delivered via sophisticated software and control systems.

NASA's moon-to-mars strategy is to create an interoperable global lunar utilization infrastructure where U.S. industry and international partners can maintain continuous robotic and human presence on the lunar surface for a robust lunar economy without NASA as the sole user, all while accomplishing science objectives and testing for Mars. Work will be performed to develop an incremental lunar power generation and distribution system that is evolvable to support continuous robotic/human operation and is capable of scaling to global power utilization and industrial power levels. Similarly, commercial and military satellites use nano/micro grids for power distribution.

The reliability of a lunar surface power grid or power distribution of the satellites hinges on the reliability of power converters that can process high voltages (e.g., greater than about 300 volts DC) needed to transmit power over long distances in a harsh lunar environment where lunar radiation can interfere with components designed to operate in earth's atmosphere. Additionally, wireless power transfer (WPT), wireless power transmission, wireless energy transmission (WET), or electromagnetic power transfer is the transmission of electrical energy without wires as a physical link. In this disclosure, WPT, WET, and/or electromagnetic power transfer are used interchangeably. WPT is particularly useful to power electrical devices in environments (e.g., lunar environments or space travel) where interconnecting wires are inconvenient, hazardous, or are not possible. In a WPT system, an electrically powered transmitter device generates a time-varying electromagnetic field that transmits power across space to a receiver device that extracts power from the field and supplies it to an electrical load. The current state-of-the-art for converters does not provide good high voltage components with radiation tolerance and WPT.

### BRIEF DESCRIPTION

Disclosed is an electric power distribution (EPD) system that includes a first power conversion system electronically connected between a first voltage source and a bus, along with a second power conversion system electronically connected between the bus and a first load. The first power conversion system is operable to, responsive to receiving power that originated from the first voltage source in a first modality, generate a first voltage and provide the first voltage to the bus. The second power conversion system is operable to, responsive to receiving a bus-voltage of the bus, generate a second voltage and provide the second voltage to the first load. The bus-voltage is greater than the second voltage.

In addition to any one or more of the features described herein, the first power conversion system is further electronically connected between a second voltage source and the bus.

In addition to any one or more of the features described herein, the second power conversion system is further electronically connected between the bus and a second load.

In addition to any one or more of the features described herein, the first power conversion system is further operable to, responsive to receiving power that originated from the second voltage source in a second modality, generate a third voltage and provide the third voltage to the bus. The second power conversion system is further operable to, responsive to receiving the bus-voltage of the bus, generate a fourth voltage and provide the fourth voltage to the second load. The bus-voltage is greater than the fourth voltage.

In addition to any one or more of the features described herein, the first power conversion system includes a first power conversion module and a second power conversion module. The first power conversion module is operable to, responsive to receiving power that originated from the first voltage source in the first modality, generate a first instance of the first voltage and provide the first instance of the first voltage to the bus. The second power conversion module is operable to, responsive to receiving power that originated from the first voltage source in the first modality, generate a second instance of the first voltage and provide the second instance of the first voltage to the bus.

In addition to any one or more of the features described herein, the first power conversion module has a first maximum voltage rating that is less than or substantially equal to the first instance of the first voltage.

In addition to any one or more of the features described herein, the second power conversion module has a second maximum voltage rating that is less than or substantially equal to the second instance of the first voltage.

In addition to any one or more of the features described herein, the first power conversion system includes a first power conversion module and a second power conversion module. The first power conversion module is operable to, responsive to receiving power that originated from the first voltage source in the first modality, generate the first voltage and provide the first voltage to the bus. The second power conversion module is operable to, responsive to receiving power that originated from the second voltage source in the second modality, generate the third voltage and provide the third voltage to the bus.

In addition to any one or more of the features described herein, the second power conversion system includes a third power conversion module and a fourth power conversion module. The third power conversion module is operable to, responsive to receiving the bus-voltage of the bus, generate the second voltage and provide the second voltage to the first load. The second power conversion module is operable to, responsive to receiving the bus-voltage of the bus, generate the fourth voltage and provide the fourth voltage to the second load.

In addition to any one or more of the features described herein, the first power source includes a laser; the second power source includes a radio frequency (RF) transmitter; the first modality includes a laser beam; the second modality includes an RF signal; the bus includes a direct current (DC) bus; the first load includes a battery; and the second load includes a wireless power transmitter.

Further disclosed is a method of making an EPD system that includes performing fabrication operations that include forming a first power conversion system electronically connected between a first voltage source and a bus, along with forming a second power conversion system electronically connected between the bus and a first load. The first power conversion system is operable to, responsive to receiving power that originated from the first voltage source in a first modality, generate a first voltage and provide the first voltage to the bus. The second power conversion system is operable to, responsive to receiving a bus-voltage of the bus, generate a second voltage and provide the second voltage to the first load. The bus-voltage is greater than the second voltage.

In addition to any one or more of the features described herein, the first power conversion system is further electronically connected between a second voltage source and the bus.

In addition to any one or more of the features described herein, the second power conversion system is further electronically connected between the bus and a second load.

In addition to any one or more of the features described herein, the first power conversion system is further operable to, responsive to receiving power that originated from the second voltage source in a second modality, generate a third voltage and provide the third voltage to the bus. The second power conversion system is further operable to, responsive to receiving the bus-voltage of the bus, generate a fourth voltage and provide the fourth voltage to the second load. The bus-voltage is greater than the fourth voltage.

In addition to any one or more of the features described herein, the first power conversion system includes a first power conversion module and a second power conversion module. The first power conversion module is operable to, responsive to receiving power that originated from the first voltage source in the first modality, generate a first instance of the first voltage and provide the first instance of the first voltage to the bus. The second power conversion module is operable to, responsive to receiving power that originated from the first voltage source in the first modality, generate a second instance of the first voltage and provide the second instance of the first voltage to the bus.

In addition to any one or more of the features described herein, the first power conversion module has a first maximum voltage rating that is less than or substantially equal to the first instance of the first voltage.

In addition to any one or more of the features described herein, the second power conversion module has a second maximum voltage rating that is less than or substantially equal to the second instance of the first voltage.

In addition to any one or more of the features described herein, the first power conversion system includes a first power conversion module and a second power conversion module. The first power conversion module is operable to, responsive to receiving power that originated from the first voltage source in the first modality, generate the first voltage and provide the first voltage to the bus. The second power conversion module is operable to, responsive to receiving power that originated from the second voltage source in the second modality, generate the third voltage and provide the third voltage to the bus.

In addition to any one or more of the features described herein, the second power conversion system includes a third power conversion module and a fourth power conversion module. The third power conversion module is operable to, responsive to receiving the bus-voltage of the bus, generate the second voltage and provide the second voltage to the first load. The second power conversion module is operable to, responsive to receiving the bus-voltage of the bus, generate the fourth voltage and provide the fourth voltage to the second load.

In addition to any one or more of the features described herein, the first power source includes a laser; the second power source includes a radio frequency (RF) transmitter; the first modality includes a laser beam; the second modality includes an RF signal; the bus includes a direct current (DC) bus; the first load includes a battery; and the second load includes a wireless power transmitter.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1A is a simplified block diagram illustrating a system in accordance with embodiments of the disclosure;

FIG. 1B is a simplified block diagram illustrating another system in accordance with embodiments of the disclosure;

FIG. 2A is a simplified block diagram illustrating another system in accordance with embodiments of the disclosure;

FIG. 2B is a simplified block diagram illustrating another system in accordance with embodiments of the disclosure;

FIG. 3 is a table summarizing differences between a known configuration of an electric power distribution system of a satellite and an electronic power distribution system embodying aspects of the disclosure;

FIG. 4A is a simplified block diagram illustrating another system in accordance with embodiments of the disclosure;

FIG. 4B is a simplified block diagram illustrating another system in accordance with embodiments of the disclosure;

FIG. 4C is a simplified block diagram illustrating another system in accordance with embodiments of the disclosure;

FIG. 5 is a simplified block diagram illustrating a non-limiting example of how a converter can be implemented in accordance with embodiments of the disclosure;

FIG. 6 is a simplified block diagram illustrating a non-limiting example of how a converter can be implemented in accordance with embodiments of the disclosure;

FIG. 7 is a simplified block diagram illustrating a non-limiting example of how a converter can be implemented in accordance with embodiments of the disclosure;

FIG. 8A is a simplified block diagram illustrating a non-limiting example of how an impedance network can be implemented in accordance with embodiments of the disclosure;

FIG. 8B is a simplified block diagram illustrating a non-limiting example of how an impedance network can be implemented in accordance with embodiments of the disclosure;

FIG. 8C is a simplified block diagram illustrating a non-limiting example of how an impedance network can be implemented in accordance with embodiments of the disclosure;

FIG. 8D is a simplified block diagram illustrating a non-limiting example of how an impedance network can be implemented in accordance with embodiments of the disclosure;

FIG. 8E is a simplified block diagram illustrating a non-limiting example of how an impedance network can be implemented in accordance with embodiments of the disclosure;

FIG. 8F is a simplified block diagram illustrating a non-limiting example of how an impedance network can be implemented in accordance with embodiments of the disclosure;

FIG. 8G is a simplified block diagram illustrating a non-limiting example of how an impedance network can be implemented in accordance with embodiments of the disclosure;

FIG. 8H is a simplified block diagram illustrating a non-limiting example of how a DC bus filter can be implemented in accordance with embodiments of the disclosure;

FIG. 8I is a simplified block diagram illustrating a non-limiting example of how a DC bus filter can be implemented in accordance with embodiments of the disclosure;

FIG. 9 is a simplified block diagram illustrating another system in accordance with embodiments of the disclosure;

FIG. 10 is a simplified block diagram illustrating another system in accordance with embodiments of the disclosure;

FIG. 11 is a simplified block diagram illustrating another system in accordance with embodiments of the disclosure; and

FIG. 12 depicts a computing system that can be utilized to implement aspects of the disclosure.

In the accompanying figures and following detailed description of the disclosed embodiments, the various elements illustrated in the figures are provided with three digit reference numbers. In some instances, the leftmost digits of each reference number corresponds to the figure in which its element is first illustrated.

### DETAILED DESCRIPTION

A detailed description of one or more embodiments of the disclosed apparatus and method are presented herein by way of exemplification and not limitation with reference to the Figures.

Embodiments of the disclosure relate in general to the field of power electronics. Power electronics is the application of electronics to the control and conversion of electric power. In modern systems, electric power conversion is performed with semiconductor switching devices such as diodes, thyristors, and power transistors such as the power MOSFET (metal-oxide-semiconductor field-effect transistor) and IGBT (insulated-gate bipolar transistor). In contrast to electronic systems concerned with the transmission and processing of signals and data, substantial amounts of electrical energy are processed in power electronics. Power conversion systems or circuits can be classified according to the type of the input and output power. In general, AC to DC power conversion systems are known as rectifiers; DC to AC power conversion systems are known as inverters; DC to DC power conversion systems are known as DC-to-DC converters; and AC to AC power conversion systems are known as AC-to-AC converters.

Embodiments of the disclosure provide a radiation-hardened modular multimodal power conversion system. The disclosed power conversion system is multimodal in that the power conversion system can process multiple sources or types of sources of the input power. For example, in some embodiments of the disclosure, the modality of the input power can include but is not limited to RF (radio frequency) power beaming WPT, laser power beaming WPT, pulsed laser power beaming WPT, batteries, PV (photovoltaic) cells, and the like.

Some embodiments of the disclosure can be implemented in electric power distribution (EPD) systems implemented in satellites. EPD systems for state-of-the-art (SOA) satellites use photovoltaic (PVs) arrays (or solar cells) for energy reception, along with batteries for energy storage. Embodiments of the disclosure augment these SOA EPD systems by providing capabilities of receiving power from or transmitting power to other satellites by wireless power beaming (e.g., RF, laser). Thus, embodiments of the disclosure can increase mission agility or robustness of a satellite system. Similarly, other space applications such as lunar microgrids, rovers for lunar exploration, or satellite to asteroids/planets can use the disclosed multimodal features of embodiments of the disclosure for transmitting/receiving power wirelessly especially where power distribution via cables is challenging. Modular aspects of the disclosure allow multiple modalities to be directly connected to the same converter while also allowing voltage/power ratings of the converter to be increased with the simple addition of more modules in series and/or in parallel.

Some embodiments of the disclosure provide a radiation hardened power conversion system operable to receive multiple power modalities at high voltages and convert the high voltages to low voltage direct current (DC). Radiation hardened converters, in general, have a limited voltage range of about 300V that is set by the voltage rating of the radiation-hardened semiconductor devices used to form the switching circuitry of the converter. Embodiments of the disclosure address this shortcoming by providing a radiation-hardened converter that scales with the voltage/power/current by the addition of more modules in series and/or in parallel.

Embodiments of the disclosure use the concepts of current, voltage, and power. In general, voltage and current are the cornerstone concepts in electricity. In order to clarify what is meant by “current,” it is necessary to first describe the concept of “charge.” The concept of electricity arises from an observation of a force between objects, that, like gravity, acts at a distance. The source of this force has been given the name charge. Opposite types of charge attract, and like types of charge repel. Charge flows in a current, and current is reported as the number of charges per unit time passing through a boundary. A positive sign is assigned to current corresponding to the direction a positive charge would be moving. Because electrons are free to move about in metals, moving electrons are what makes up the current in metals.

Voltage, also called electromotive force, is a quantitative expression of the potential difference in charge between two points in an electrical field. The greater the voltage, the greater the flow of electrical current (i.e., the quantity of charge carriers that pass a fixed point per unit of time) through a conducting or semiconducting medium for a given resistance to the flow. The standard unit to measure voltage is the volt, symbolized by a non-italic uppercase letter V. One volt will drive one coulomb (6.24×10¹⁸) charge carriers, such as electrons, through a resistance of one ohm in one second. Voltage can be direct or alternating. A direct voltage maintains the same polarity at all times. In an alternating voltage, the polarity reverses direction periodically. The number of complete cycles per second is the frequency, which is measured in hertz (one cycle per second), kilohertz, megahertz, gigahertz, or terahertz. An example of direct voltage is the potential difference between the terminals of an electrochemical cell. Alternating voltage exists between the terminals of a common utility outlet. A voltage produces an electrostatic field, even if no charge carriers move (i.e., no current flows). As the voltage increases between two points separated by a specific distance, the electrostatic field becomes more intense.

Power is what happens when voltage and current act together. Electric power is defined as the electrical energy transferred in a circuit per unit of time. The unit of electric power is the Watt (W) and is denoted by the symbol P. It is often measured in kilowatts (kW), where 1 kW=1000 W. The electrical power used by an electrical component depends on two main factors, namely, the current/passing through the component, along with the potential difference or voltage across the two ends of the component. Increasing either current or voltage will increase the power proportionally. The electric power transferred to an electrical component in a circuit can be calculated using the electric power formula P=VI, where P is the electric power, V is the potential difference across the component, and I is the current passing through the component. The electric power can also be calculated by knowing the current and resistance using the equation P=I²R, where R is the resistance of the electrical component.

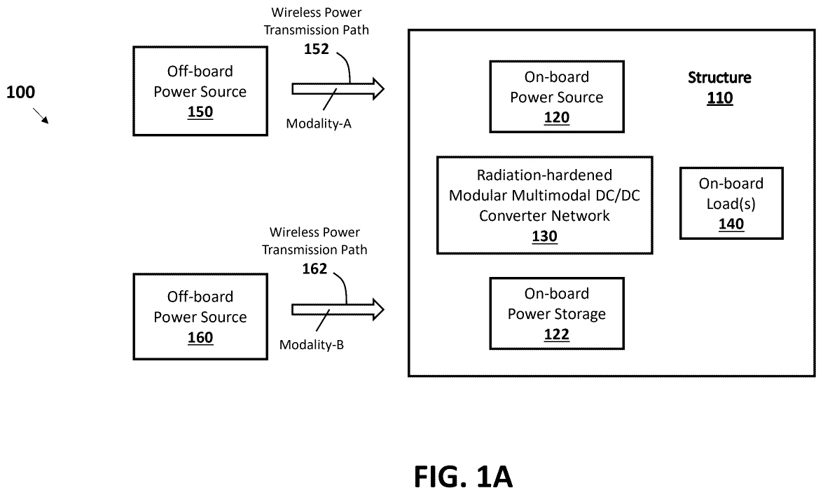

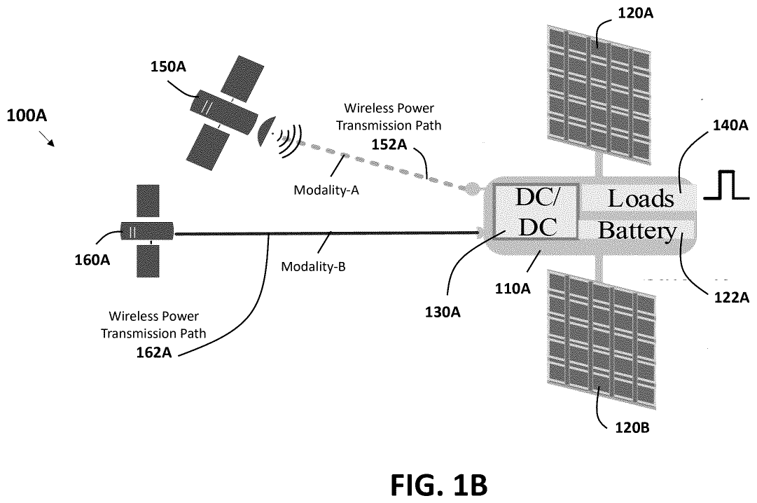

FIG. 1A is a simplified block diagram illustrating a system 100 in accordance with embodiments of the disclosure. The system 100 includes a structure 110 in wireless communication with an off-board power source 150 and an off-board power source 160. The off-board power source 150 uses a wireless power transmission path 152 to wirelessly transfer power having Modality-A (e.g., RF power signals) to the structure 110. The off-board power source 160 uses a wireless power transmission path 162 to wirelessly transfer power having Modality-B (e.g., a laser beam or a pulsed laser beam) to the structure 110. The structure 110 includes a radiation-hardened modular multimodal DC/DC converter network 130 operable to receive Modality-A and/or Modality-B and use the same to power on-board loads 140 on the structure 110. The structure 110 further includes an on-board power source (e.g., PV cells) 120 and an on-board power storage (e.g., a battery) 122. In embodiments of the disclosure, the power storage 122 can be reloaded or recharged using the on-board power-source 120 and/or the wirelessly transmitted power in Modality-A and/or Modality-B received at the radiation-tolerate modular multimodal DC/DC converter network 130. In some embodiments of the disclosure, the network 130 wirelessly receives power in Modality-A and/or Modality-B at a higher voltage (e.g., at or above about 300V), transmits the higher voltage over a DC bus, extracts the higher voltage from the DC bus, and steps the higher voltage down to a lower voltage (e.g., 28 V) and provides the lower voltage to the on-board loads 140. In some embodiments of the disclosure, the on-board loads 140 can include a transmitter operable to transmit wireless power out of the structure 110 to other structures.

FIG. 1B is a simplified block diagram illustrating a system 100A in accordance with embodiments of the disclosure. The system 100A includes a satellite 110A in wireless communication a satellite 150A operable to function as an off-board power source, as well as a satellite 160A operable to function as an off-board power source. The satellite 150A uses a wireless power transmission path 152A to wirelessly transfer power having Modality-A (e.g., RF power signals) to the satellite 110A. The satellite 160A uses a wireless power transmission path 162A to wirelessly transfer power having Modality-B (e.g., a laser beam or a pulsed laser beam) to the satellite 110A. The satellite 110A includes a radiation-hardened modular multimodal DC/DC converter network 130A operable to receive Modality-A and/or Modality-B and use the same to power an on-board load/battery 140A on the satellite 110A. The satellite 110A further includes PV cells 120A, 120B, which function as an on-board power source. The satellite 110A further includes one or more batteries 122A that function as an on-board power storage. In embodiments of the disclosure, the batteries 122A can be reloaded or recharged using the PV cells 120A, 120B and/or the wirelessly transmitted power in Modality-A and/or Modality-B received at the radiation-tolerate modular multimodal DC/DC converter network 130A. In some embodiments of the disclosure, the network 130A wirelessly receives power in Modality-A and/or Modality-B at a higher voltage (e.g., at or above about 300V), transmits the higher voltage over a DC bus, extracts the higher voltage from the DC bus, and steps the higher voltage down to a lower voltage (e.g., 28 V) and provides the lower voltage to the batteries 122 and/or the on-board loads 140A. In some embodiments of the disclosure, the on-board loads 140A can include a transmitter operable to transmit wireless power out of the satellite 110A to other structures, including other satellites.

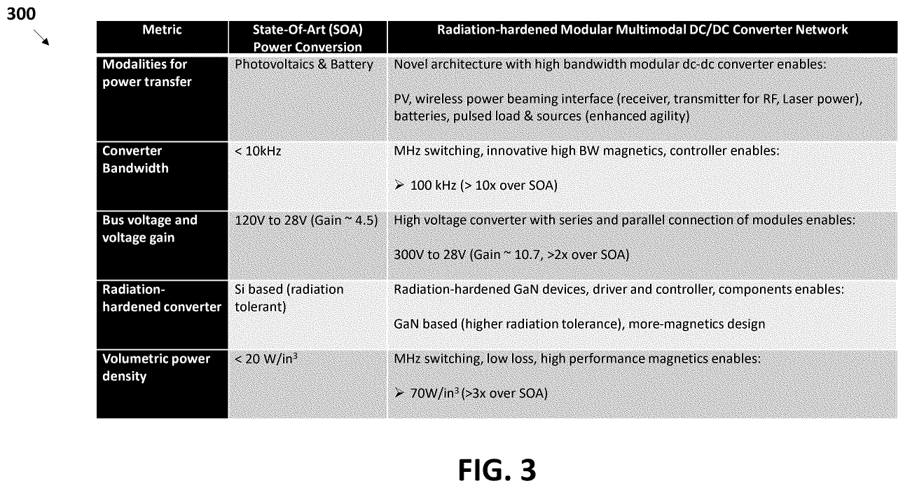

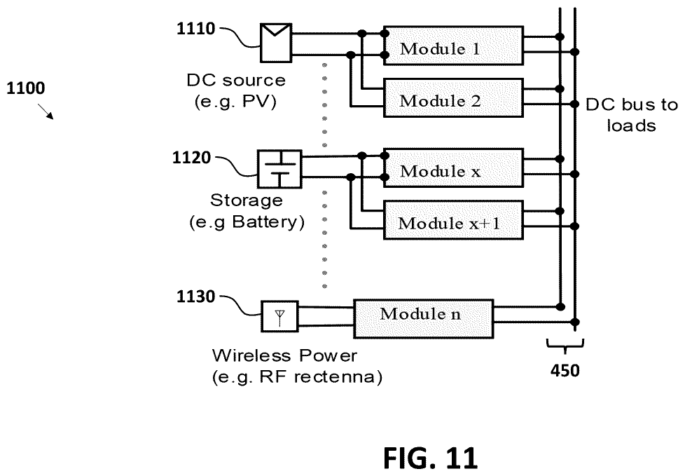

The systems 100, 100A and the radiation-hardened modular and multimodal DC/DC converter 130, 130A enable the implementation of a resilient power distribution system based on new and enhanced capabilities provided by the disclosed multi-modal operation with very high bandwidth, high power, and high density. In known satellite-based EPD systems, power is distributed using lower voltages (e.g., 28V, 120V), and the weight of the power distribution system becomes significantly heavy with the increasing power demand from new satellite designs. To address these challenges, embodiments of the disclosure provide a GaN-based (i.e., higher radiation tolerance converter components having GaN-based devices) high voltage (e.g. >300 V) high power modular dc-dc converter 130A with significant improvement over SOA EPD systems, as shown in Table 300 of FIG. 3. The power converter 130A can be modular, which enables voltage and power provided by the power converter(s) 130A to be scaled to even higher voltages and higher power levels with series and parallel combination of the modules (e.g., Module x, Module x+1, etc. shown in FIG. 11)). Furthermore, known isolated DC-DC converters used for power management and distribution (PMAD) of conventional systems have poor power density and low control bandwidth (100 Hz to 5 kHz), and hence, cannot be used for tracking very fast dynamics of loads and sources, such as a pulsed load reaching 20 kW to 50 kW, and/or pulse-type wireless power beaming. The power converter 130A can be based on advanced power devices (e.g., power devices formed from high-radiation-tolerant GaN) with very high switching frequency (e.g. MHz class) and magnetic components to achieve orders of magnitudes improvement in bandwidth compared to state-of-art solutions that will permit faster tracking of pulsed sources and loads, and 3× improvement in volumetric power density of the converters 130A, which will free up more space on the satellite 110A to include additional sensors and devices on satellite implementations, as well as rovers and power distribution systems of lunar microgrid implementations. The scalability of the modular power electronic converter 130A enables the realization of a radiation-hardened design at the module level (e.g., by using radiation-hardened power devices) and achieve radiation-hardened higher power or higher voltage system by series and parallel combination of the modules.

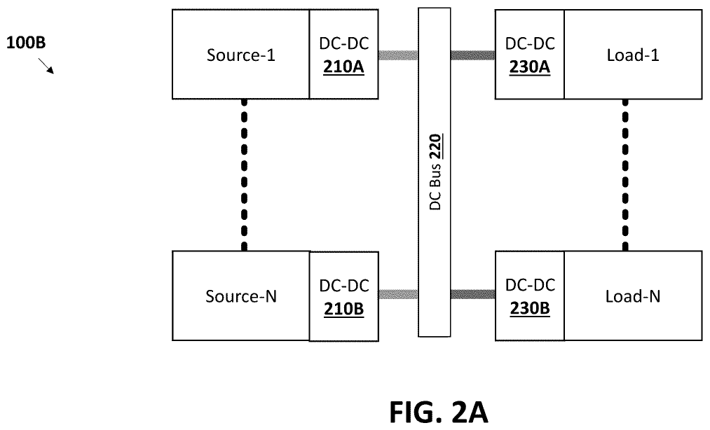

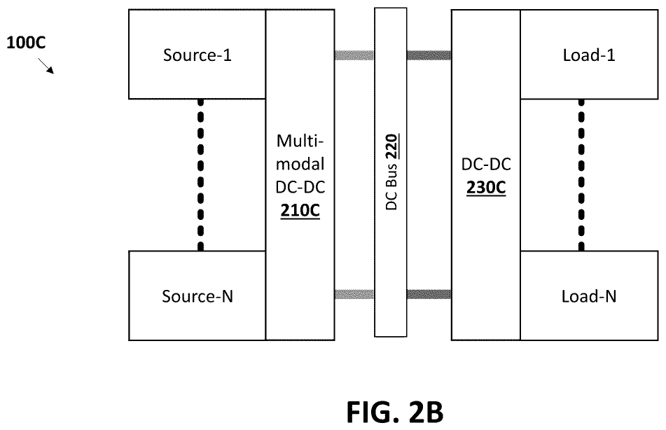

FIG. 2A is a simplified block diagram illustrating a system 100B in accordance with embodiments of the disclosure. The system 100B includes multiples power sources identified in FIG. 2A as Source-1 through Source-N, where N=a whole number. Each of Source-1 through Source-N is electronically coupled (e.g., wirelessly) to a DC-DC converter module, which is represented as DC-DC converter 210A for Source-1 and DC-DC converter 210B for Source-N. The DC-DC converters 210A, 210B electronically couple to a DC bus 220 from an input side of the bus 220. The system 100B further includes multiples loads identified in FIG. 2A as Load-1 through Load-N, where N=a whole number. Each of Load-1 through Load-N is electronically coupled to a DC-DC converter module, which is represented as DC-DC converter 230A for Load-1 and DC-DC converter 230B for Load-N. The DC-DC converters 230A, 230B couple to a DC bus 220 from an output side. The DC-DC converters 210A, 210B, 230A, 230B make up components of the radiation-hardened modular multi-modal DC/DC converter network 130 (shown in FIG. 1A) and are configured to perform the features and functionality of the radiation-hardened modular multi-modal DC/DC converter network 130 as described herein. Power density can be improved by providing a system 100C shown in FIG. 2B, which is substantially the same as the system 100B except in system 100C the DC-DC converters 210A, 210B are implemented as a single multi-modal DC-DC converter 210C, and the DC-DC converters 230A, 230B are implemented as a single DC-DC converter 230C. The single multi-modal DC-DC converter 210C and the single DC-DC converter 230C are operable to process dynamics of multiple sources and loads, respectively.

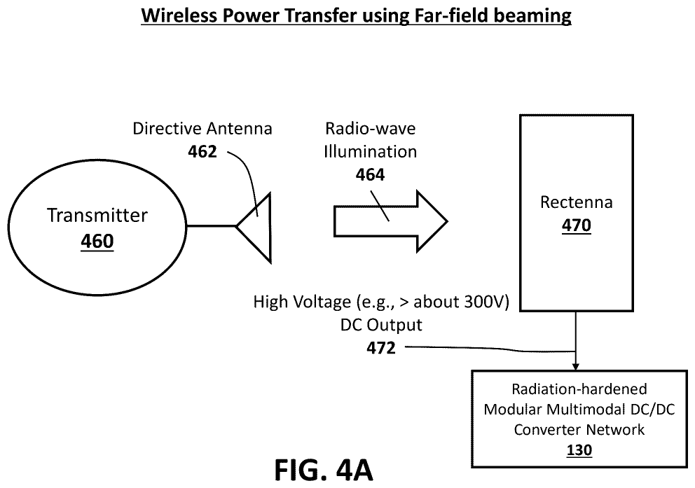

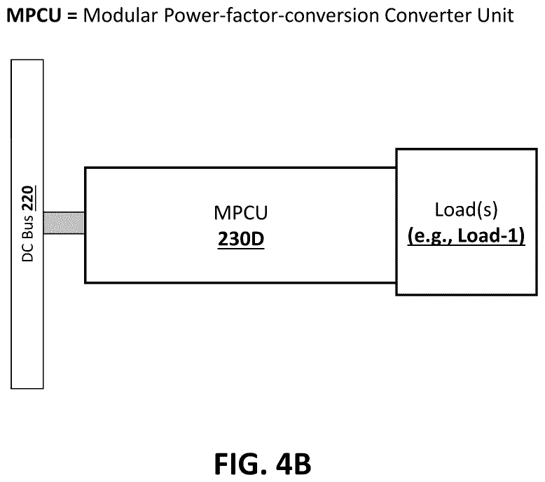

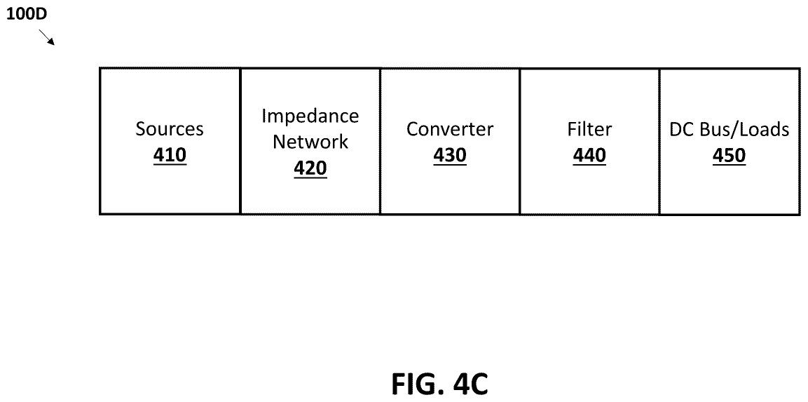

FIG. 4A depicts a simplified block diagram illustrating a non-limiting example of how a wireless power transfer using far-field beaming can be implemented in accordance with embodiments of the disclosure. A transmitter 460 and directive antenna 462 are provided on, for example, either or both of the satellites 150A, 160A (shown in FIG. 1B). The transmitter 460 and directive antenna 462 transmit radio-wave illumination 464 having a modality (e.g., Modality-A, Modality-B, and the like) to a rectenna (rectifying antenna) 470. In general, a rectenna is a special type of receiving antenna that is used for converting electromagnetic energy into direct current (DC) electricity. In some embodiments of the disclosure, the rectenna 470 can be implemented as a dipole antenna with a diode connected across the dipole elements. The diode rectifies the AC induced in the antenna by the microwaves to produce DC power (e.g., the high voltage (e.g., >about 300V) DC output 472, which is provided to the radiation-hardened modular and multimodal DC/DC converter 130. In some embodiments of the disclosure, the rectenna 470 and the radiation-hardened modular and multimodal DC/DC converter 130 are implemented on the satellite 110A (shown in FIG. 1B). In some embodiments of the disclosure, the rectenna 470 can be implemented as a rectenna array, which can be implemented as the PV array 120A, 120B (shown in FIG. 1B). In general, a rectenna array uses multiple antennas spread over a wide area to capture more energy.

FIG. 4B depicts a simplified block diagram illustrating a non-limiting example of how the DC-DC converters 230A, 230B, 230C of the systems 100B, 100C (shown in FIGS. 2A and 2B) can be implemented a modular power-factor-conversion converter unit (MPCU) 230D in accordance with embodiments of the disclosure. In embodiments of the disclosure, the MPCU 230D is operable to perform voltage step down and conversation operations embodying aspects of the present disclosure. Where multiple MPCUs 230D are provided, the MPCUs 230D can be connected to one another in parallel and/or in series. The MPCU 230D acts as an interface in between a higher voltage DC on the DC bus 220 and the low voltage (e.g., 120V) components of the Load(s) (e.g., Load-1).

FIG. 4C is a simplified block diagram illustrating a system 100D in accordance with embodiments of the disclosure. The system 100D includes sources (e.g., power sources) 410, an impedance network 420, a converter 430, a filter 440, and DC bus and/or load components, configured and arranged as shown. The overall structure of the system 100D would have the sources 410 on one side, and the impedance network (e.g., a passive impedance network) 420 formed as an interconnection of capacitors and inductors and resistors. The impedance network 420 is followed by the converter 430, which corresponds to the radiation-hardened modular and multimodal DC/DC converter 130 (shown in FIG. 1B). A filter 440 is downstream from the converter 430. The filter 440 can be implemented as a combination of resistors, capacitors and inductors connected in a way to act as a buffer or a filter, filtering on either harmonics, switching transitions, or any such aspect as required by the application. The filter 440 feeds to the DC bus and/or loads 450, which corresponds to the DC bus 220 and the loads Load-1 through Load-N. As needed, the location of these blocks namely sources 410, impedance network 420, converter 430, filter 440 and DC bus/loads 450 can be swapped with each other.

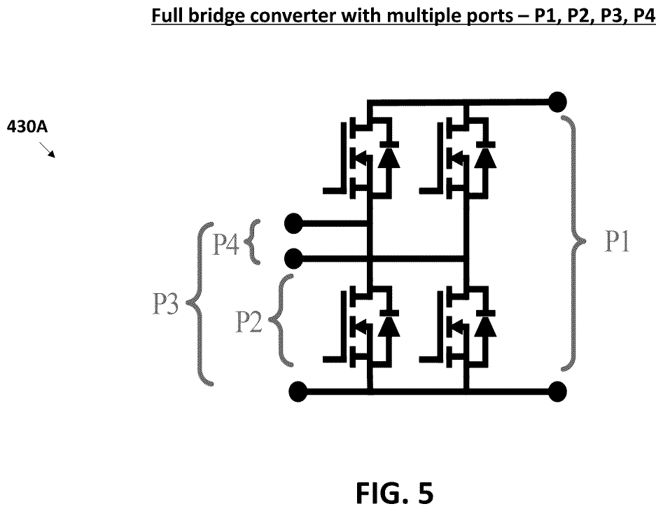

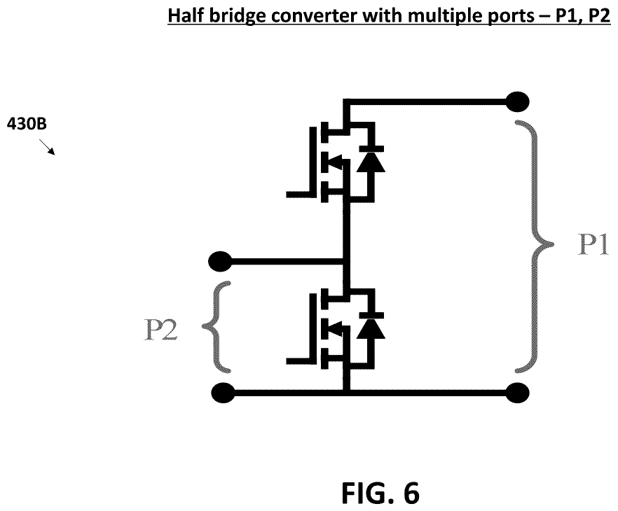

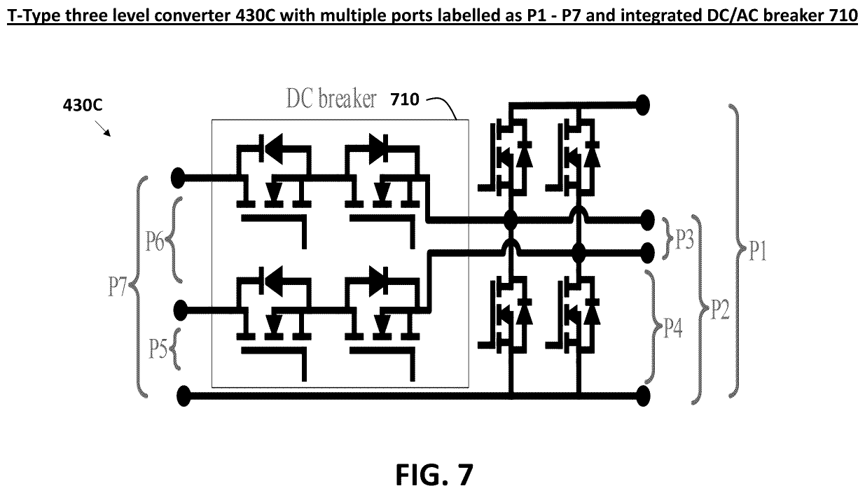

FIGS. 5, 6, and 7 illustrate non-limiting examples of converter circuit topologies that are appropriate for multimodal architectures of the converter 430. More specifically, FIG. 5 depicts a full bridge converter 430A with multiple ports P1, P2, P3, P4; FIG. 6 depicts a full bridge converter 430B with multiple ports P1, P2; and FIG. 7 depicts a t-type three level converter 430C with multiple ports P1-P7 and an integrated DC/AC breaker 710. Individual ports can be configured for AC to DC or DC to DC voltage conversion. The DC circuit breaker 710 eliminates the need for a separate DC circuit breaker which is needed for fault protection.

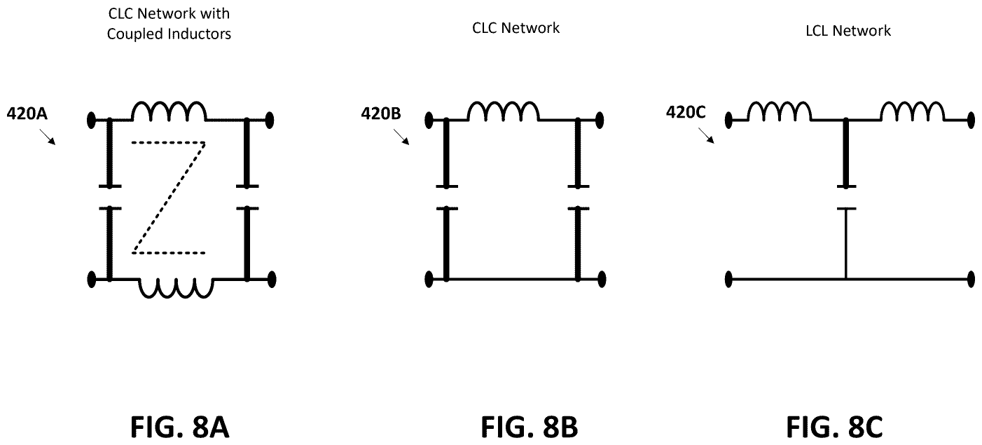

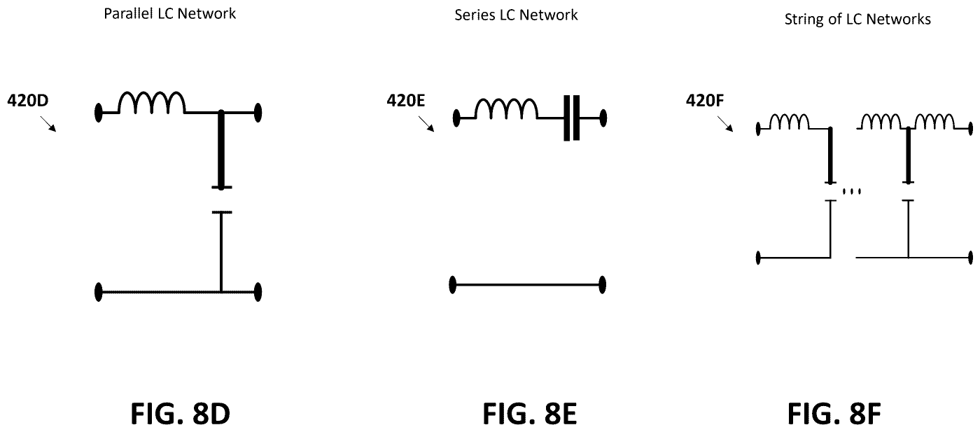

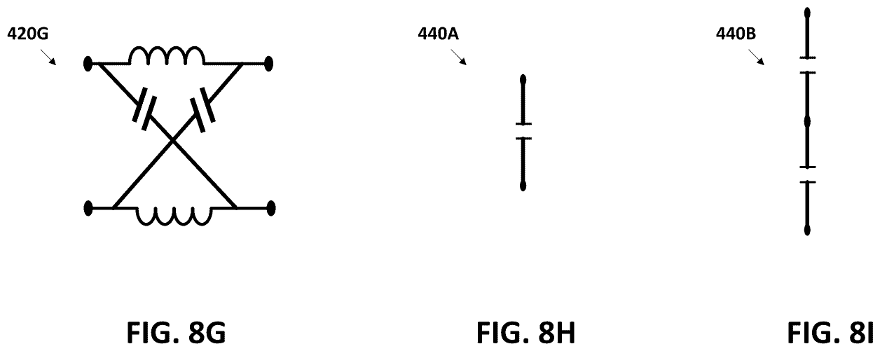

FIGS. 8A-8G illustrate non-limiting examples of impedance network topologies that are appropriate for implementing the impedance network 420. Each impedance network topology would have its own frequency response corresponding to the requirements of the specific application. More specifically, FIG. 8A depicts a CLC network 420A with coupled inductors; FIG. 8B depicts a CLC network 420B; FIG. 8C depicts an LCL network 420C; FIG. 8D depicts a parallel LC network 420D; FIG. 8E depicts a series LC network 420E; FIG. 8F depicts a string of LC Networks 420F; and 8G depicts a Z impedance network 420G.

FIGS. 8H and 8I illustrate non-limiting examples of filter topologies that are appropriate for implementing the filter 440. Each filter shown in FIGS. 8H and 8I can be provided with its own filtering response corresponding to the requirements of the specific application. More specifically, FIG. 8H depicts a single DC bus filter capacitor 440A; and FIG. 8I depicts a center-tapped DC bus filter capacitor 440B.

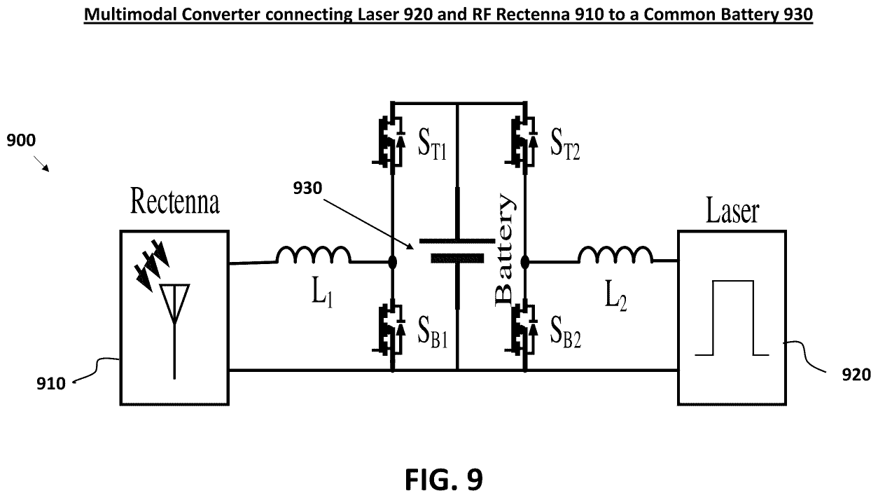

FIG. 9 is a simplified block diagram illustrating a system 900 in accordance with embodiments of the disclosure. The system 900 includes a rectenna 910 coupled to a battery 930 through an inductor L1 and switching elements ST1 and SB1. The system 900 further includes a laser 920 coupled to the battery 930 through an inductor L2 and switching elements ST2 and SB2. The system 900 is a non-limiting example of the modular and multimodal converter 430, where switches ST1, SB1 and inductor L1 is part of Module-1 and switches ST2, SB2 and inductor L2 are all part of Module-2. Modules-1 and Module-2 are used to connect RF rectenna 910 and pulsed laser sources 920, respectively, to the battery 930, which can be connected to a load and/or a DC bus (e.g., DC bus/loads 450 shown in FIG. 4C).

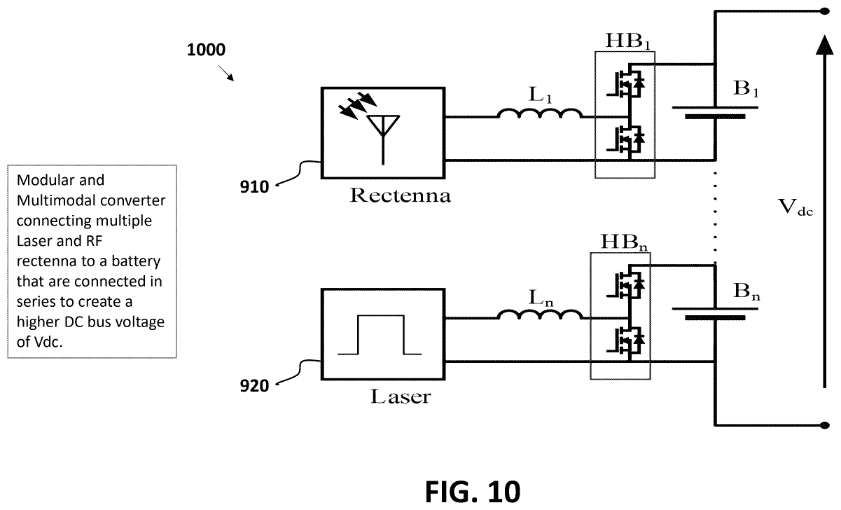

FIG. 10 is a simplified block diagram illustrating a system 1000 in accordance with embodiments of the disclosure. The system 1000 includes the rectenna 910 coupled to a battery B1 through an inductor L1 and half-bridge switching elements HB1. The system 1000 further includes the laser 920 coupled to a battery BN (where N is a whole number) through an inductor L2 and half-bridge switching elements HBN. The system 1000 is a non-limiting example of the modular and multimodal converter 430, where switches HB1 and inductor L1 are part of Module-1 and switches HB2 and inductor L2 are all part of Module-N (where N is a whole number). The modular and multimodal converter (Module-1 through Module-N) connects multiple Laser 920 and RF rectenna 910 to a network of battery elements B1 through BN that are connected in series to create a higher DC bus voltage of Vdc. The multiple batteries B1 through BN can be connected in series to increase the de bus voltage Vdc, and here each source supplies power to its respective battery with a half bridge module, HB, which can be replaced by other converters topologies 430A, 430B, 430C shown in FIGS. 5, 6, and 7, respectively.

FIG. 11 is a simplified block diagram illustrating a system 1100 in accordance with embodiments of the disclosure. The system 1100 is an example of how the modules (e.g., shown in FIGS. 9 and 10) of the modular multi-modal converter 430 can also be connected in parallel to scale up for higher power and multiple sources, storage, and loads. The system 1100 illustrates a DC source 1110 coupled through Module-1 and Module-2 to the DC bus/loads 450; a storage battery 1120 coupled to though Modul-X and Module-(X+1) to the DC bus/loads 450; and a wireless power source (e.g., an RF rectenna) 1130 coupled through Module-n to the DC bus/loads 450. The system 1100 provides higher power for multiple sources and storages, which can be applicable for the load side as well. In this proposed configuration the individual modules can be designed to be radiation tolerant and qualified for operation under the desired radiation conditions, which then can be integrated at the system level to achieve an overall radiation tolerant high power electronic converter 430.

Embodiments of the disclosure provide various processor-based control operations of the EPD systems 100-100D, 900, 1000, 1100 disclosed herein. In some embodiments of the disclosure, the processor-based control operations can be performed using cognitive algorithms executed by a controller (e.g., the computing system 1200). In embodiments of the disclosure, a cognitive algorithm refers to a variety of algorithm types that generate and apply computerized models to simulate the human thought process in complex situations where the answers might be ambiguous and uncertain. A conventional cognitive algorithm includes self-learning technologies that use data mining, pattern recognition, natural language processing (NLP), and other related technologies to generate the mathematical models that make decisions (e.g., classifications, predictions, and the like) that, in effect, mimic human intelligence.

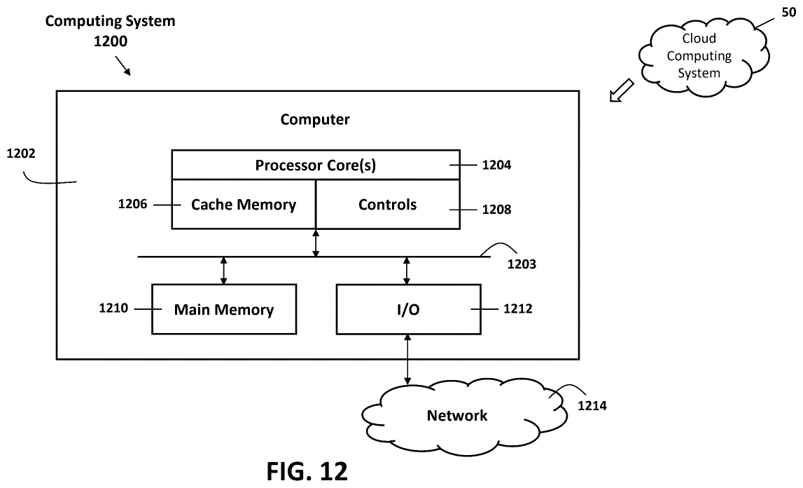

FIG. 12 illustrates an example of a computer system 1200 that can be used to implement the various processor-based operations and/or cognitive algorithms described herein. The computer system 1200 includes an exemplary computing device (“computer”) 1202 configured for performing various aspects of the content-based semantic monitoring operations described herein in accordance embodiments of the disclosure. In addition to computer 1202, exemplary computer system 1200 includes network 1214, which connects computer 1202 to additional systems (not depicted) and can include one or more wide area networks (WANs) and/or local area networks (LANs) such as the Internet, intranet(s), and/or wireless communication network(s). Computer 1202 and additional system are in communication via network 1214, e.g., to communicate data between them.

Exemplary computer 1202 includes processor cores 1204, main memory (“memory”) 1210, and input/output component(s) 1212, which are in communication via bus 1203. Processor cores 1204 includes cache memory (“cache”) 1206 and controls 1208, which include branch prediction structures and associated search, hit, detect and update logic, which will be described in more detail below. Cache 1206 can include multiple cache levels (not depicted) that are on or off-chip from processor 1204. Memory 1210 can include various data stored therein, e.g., instructions, software, routines, etc., which, e.g., can be transferred to/from cache 1206 by controls 1208 for execution by processor 1204. Input/output component(s) 1212 can include one or more components that facilitate local and/or remote input/output operations to/from computer 1202, such as a display, keyboard, modem, network adapter, etc. (not depicted).

A cloud computing system 50 is in wired or wireless electronic communication with the computer system 1200. The cloud computing system 50 can supplement, support or replace some or all of the functionality (in any combination) of the computing system 1200. Additionally, some or all of the functionality of the computer system 1200 can be implemented as a node of the cloud computing system 50A.

For the sake of brevity, conventional techniques related to making and using the disclosed embodiments may or may not be described in detail herein. In particular, various aspects of computing systems and specific computer programs to implement the various technical features described herein are well known. Accordingly, in the interest of brevity, many conventional implementation details are only mentioned briefly or are omitted entirely without providing the well-known system and/or process details.

For convenience, some of the technical operations described herein are conveyed using informal expressions. For example, a processor that has data stored in its cache memory can be described as the processor “knowing” the data. Similarly, a user sending a load-data command to a processor can be described as the user “telling” the processor to load data. It is understood that any such informal expressions in this detailed description should be read to cover, and a person skilled in the relevant art would understand such informal expressions to cover, the formal and technical description represented by the informal expression.

Many of the functional units of the systems described in this specification have been labeled as modules. Embodiments of the disclosure apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together, but can include disparate instructions stored in different locations which, when joined logically together, function as the module and achieve the stated purpose for the module.

The various components/modules/models of the systems illustrated herein are depicted separately for ease of illustration and explanation. In embodiments of the disclosure, the functions performed by the various components/modules/models can be distributed differently than shown without departing from the scope of the various embodiments of the disclosure describe herein unless it is specifically stated otherwise.

Aspects of the disclosure can be embodied as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The terms “about,” “substantially,” “substantial,” “approximately,” and equivalents thereof are intended to include the degree of error associated with measurement of the particular quantity based upon the equipment available at the time of filing the application. For example, “about” can include a range of +8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An electric power distribution (EPD) system comprising:
a first power conversion system electronically connected between a first voltage source and a bus; and
a second power conversion system electronically connected between the bus and a first load;
wherein the first power conversion system is operable to, responsive to receiving power that originated from the first voltage source in a first modality, generate a first voltage and provide the first voltage to the bus;
wherein the second power conversion system is operable to, responsive to receiving a bus-voltage of the bus, generate a second voltage and provide the second voltage to the first load; and
wherein the bus-voltage is greater than the second voltage.

2. The EPD system of claim 1, wherein the first power conversion system is further electronically connected between a second voltage source and the bus.

3. The EPD system of claim 2, wherein the second power conversion system is further electronically connected between the bus and a second load.

4. The EPD system of claim 3, wherein:
the first power conversion system is further operable to, responsive to receiving power that originated from the second voltage source in a second modality, generate a third voltage and provide the third voltage to the bus;
the second power conversion system is further operable to, responsive to receiving the bus-voltage of the bus, generate a fourth voltage and provide the fourth voltage to the second load; and
the bus-voltage is greater than the fourth voltage.

5. The EPD system of claim 4, wherein:
the first power conversion system comprises a first power conversion module and a second power conversion module;
the first power conversion module is operable to, responsive to receiving power that originated from the first voltage source in the first modality, generate a first instance of the first voltage and provide the first instance of the first voltage to the bus; and
the second power conversion module is operable to, responsive to receiving power that originated from the first voltage source in the first modality, generate a second instance of the first voltage and provide the second instance of the first voltage to the bus.

6. The EPD system of claim 5, wherein the first power conversion module has a first maximum voltage rating that is less than or substantially equal to the first instance of the first voltage.

7. The EPD system of claim 6, wherein the second power conversion module has a second maximum voltage rating that is less than or substantially equal to the second instance of the first voltage.

8. The EPD system of claim 4, wherein:
the first power conversion system comprises a first power conversion module and a second power conversion module;
the first power conversion module is operable to, responsive to receiving power that originated from the first voltage source in the first modality, generate the first voltage and provide the first voltage to the bus; and
the second power conversion module is operable to, responsive to receiving power that originated from the second voltage source in the second modality, generate the third voltage and provide the third voltage to the bus.

9. The EPD system of claim 8, wherein:
the second power conversion system comprises a third power conversion module and a fourth power conversion module;
the third power conversion module is operable to, responsive to receiving the bus-voltage of the bus, generate the second voltage and provide the second voltage to the first load; and
the second power conversion module is operable to, responsive to receiving the bus-voltage of the bus, generate the fourth voltage and provide the fourth voltage to the second load.

10. The EPD system of claim 4, wherein:
the first power source comprises a laser;
the second power source comprises a radio frequency (RF) transmitter;
the first modality comprises a laser beam;
the second modality comprises an RF signal;
the bus comprises a direct current (DC) bus;
the first load comprises a battery; and
the second load comprises a wireless power transmitter.

11. A method of forming an electric power distribution (EPD) system, the method comprising performing fabrication operations comprising:
forming a first power conversion system electronically connected between a first voltage source and a bus; and
forming a second power conversion system electronically connected between the bus and a first load;
wherein the first power conversion system is operable to, responsive to receiving power that originated from the first voltage source in a first modality, generate a first voltage and provide the first voltage to the bus;
wherein the second power conversion system is operable to, responsive to receiving a bus-voltage of the bus, generate a second voltage and provide the second voltage to the first load; and
wherein the bus-voltage is greater than the second voltage.

12. The method of claim 11, wherein the first power conversion system is further electronically connected between a second voltage source and the bus.

13. The method of claim 12, wherein the second power conversion system is further electronically connected between the bus and a second load.

14. The method of claim 13, wherein:
the first power conversion system is further operable to, responsive to receiving power that originated from the second voltage source in a second modality, generate a third voltage and provide the third voltage to the bus;
the second power conversion system is further operable to, responsive to receiving the bus-voltage of the bus, generate a fourth voltage and provide the fourth voltage to the second load; and
the bus-voltage is greater than the fourth voltage.

15. The method of claim 14, wherein:
the first power conversion system comprises a first power conversion module and a second power conversion module;
the first power conversion module is operable to, responsive to receiving power that originated from the first voltage source in the first modality, generate a first instance of the first voltage and provide the first instance of the first voltage to the bus; and
the second power conversion module is operable to, responsive to receiving power that originated from the first voltage source in the first modality, generate a second instance of the first voltage and provide the second instance of the first voltage to the bus.

16. The method of claim 15, wherein the first power conversion module has a first maximum voltage rating that is less than or substantially equal to the first instance of the first voltage.

17. The method of claim 16, wherein the second power conversion module has a second maximum voltage rating that is less than or substantially equal to the second instance of the first voltage.

18. The method of claim 14, wherein:
the first power conversion system comprises a first power conversion module and a second power conversion module;
the first power conversion module is operable to, responsive to receiving power that originated from the first voltage source in the first modality, generate the first voltage and provide the first voltage to the bus; and
the second power conversion module is operable to, responsive to receiving power that originated from the second voltage source in the second modality, generate the third voltage and provide the third voltage to the bus.

19. The method of claim 18, wherein:
the second power conversion system comprises a third power conversion module and a fourth power conversion module;
the third power conversion module is operable to, responsive to receiving the bus-voltage of the bus, generate the second voltage and provide the second voltage to the first load; and
the second power conversion module is operable to, responsive to receiving the bus-voltage of the bus, generate the fourth voltage and provide the fourth voltage to the second load.

20. The method of claim 14, wherein:
the first power source comprises a laser;
the second power source comprises a radio frequency (RF) transmitter;
the first modality comprises a laser beam;
the second modality comprises an RF signal;
the bus comprises a direct current (DC) bus;
the first load comprises a battery; and
the second load comprises a wireless power transmitter.
